(19) United States
(12) Patent Application Publication
(10) Pub. No.: US 2009/0327038 A1
(43) Pub. Date: Dec. 31, 2009

(54) METHODS AND APPARATUS FOR ELECTRONIC COMMERCE

(75) Inventor: Chad Petersen, Rochester, MN (US)

Correspondence Address: SCHWEGMAN, LUNDBERG & WOESSNER, P.A., P.O. BOX 2938, MINNEAPOLIS, MN, 55402, US

(73) Assignee: eHaggle, LLC

(21) Appl. No.: 12/210,011

(22) Filed: Sep. 12, 2008

Related U.S. Application Data
(63) Continuation of application No. 12/163,642, filed on Jun. 27, 2008.

(51) Int. Cl. G06Q 10/00

(52) U.S. Cl. 705/10

(57) ABSTRACT

The present subject matter provides methods of electronic commerce comprising generating an online catalog of items, collecting consumer interest data for online catalog items using consumer initiated selections of the item from a dedicated web site, aggregating the consumer interest data in a database, determining a demand forecast for the item the consumer interest data, electronically receiving supplier bids to supply the demand forecast, electronically receiving contingent buyer commitments in response to an accepted supplier bid; and closing commerce in the item. Additional examples include monitoring a supplier's return inventory using an inventory management system to develop electronic commerce.

### RELATED APPLICATIONS

This Application is a continuation of U.S. patent application Ser. No. 12/163,642 filed Jun. 27, 2008 which is incorporated herein by reference and made a part hereof. This application is related to U.S. patent application Ser. No. 12/163,849 filed Jun. 27, 2008, and U.S. patent application Ser. No. ______ filed Sep. 12, 2008, SLW Attorney Docket No. 2730.002US2, which are incorporated herein by reference and made a part hereof.

### FIELD

The present subject matter relates generally to methods and apparatus for electronic commerce and more particularly to methods and apparatus for aggregating consumer interest for transactions between online consumers and online suppliers.

### BACKGROUND

Online commerce has become a substantial industry of its own as the Internet and World Wide Web have evolved, reaching an estimated $31.1 billion for the 2007 holiday season including November and December 2007 (eMarketer, November 2007). For suppliers, online commerce represents a relatively inexpensive method of exposing the supplier's items to a large number of potential consumers. For consumers, online commerce represents an opportunity to get bargains from the reduced cost of sales and ease of research about the purchase. Economic supply and demand theory predicts that the potential to increase the benefit of both the suppliers and consumers exists if consumers can pool their individual interests and collectively bargain with a supplier. However, consumers typically do not want to commit to a sale until they know a price, and suppliers cannot give volume discount pricing until they know the volume. Therefore, striking a bargain with either unknown prices or unknown volume is difficult, if not impossible outside of a trust relationship. What is needed in the art is a system for commerce that incentives consumers to safely express their interest and suppliers to provide offers based on that interest to achieve more economically efficient transactions.

### SUMMARY

The present subject matter includes a system for electronic commerce for an item comprising collecting consumer interest data for the item using consumer initiated selections of the item from a dedicated web site, aggregating the consumer interest data in a database determining a demand forecast for the item using the consumer interest data, electronically receiving supplier bids to supply the demand forecast, electronically receiving contingent buyer commitments in response to an accepted supplier bid and closing commerce in the item. Various examples provide a method of electronic commerce for a product, the method comprising collecting consumer interest data for the product in a database using a network, determining a demand forecast for the product using historical item data and the consumer interest data, electronically receiving selected inventory information from an inventory management system of at least one supplier, determining the demand forecast satisfies a predetermined demand forecast threshold, monitoring a return inventory of the product using the supplier's inventory management system, determining the return inventory satisfies the predetermined demand forecast threshold, presenting a price for a sale of the product from the return inventory to a plurality of potential consumers, electronically collecting contingent buyer commitments in response to the price and electronically charging an account for each contingent buyer commitment satisfying the price.

This Summary is an overview of some of the teachings of the present application and is not intended to be an exclusive or exhaustive treatment of the present subject matter. Further details about the present subject matter are found in the detailed description and the appended claims. The scope of the present invention is defined by the appended claims and their legal equivalents.

### BRIEF DESCRIPTION OF THE DRAWINGS

FIG. 1 shows a flow diagram for a method of developing electronic commerce according to one embodiment of the present subject matter.

FIG. 2 shows an information flow diagram for developing electronic commerce according to one embodiment of the present subject matter.

FIGS. 3A-D are process flow diagrams for a web commerce system according to one embodiment of the present subject matter.

FIG. 4 illustrates a process flow diagram of a network commerce system according to one embodiment of the present subject matter.

FIG. 5 illustrates a process flow diagram for a network commerce system according to one embodiment of the present subject matter.

FIG. 6 illustrates a flow diagram of a method for conducting commerce using a network according to one embodiment of the present subject matter.

FIG. 7 illustrates a flow diagram for conducting a “negotiation” for an item 673 according to one embodiment of the present subject matter.

FIG. 8 illustrates a process for processing a transaction 674 arising from a “negotiation” according to one embodiment of the present subject matter.

FIG. 9 shows a flow diagram of a process for electronic commerce between businesses using a supplier's returns inventory according to one embodiment of the present subject matter.

### DETAILED DESCRIPTION

The following detailed description refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

In various embodiments, an electronic commerce system according to the present subject matter allows consumers to indicate items they may consider purchasing. The indicated quantities, or consumer interest, of an item are accumulated, processed and an estimated quantity is made available to suppliers of such items to encourage suppliers to offer a sales bid based on a given sales volume. In various embodiments, a consumer indicating interest in an item is not initially bound to purchase the item. Additionally, a consumer indicating interest in an item need not indicate a purchase price for the item. Depending on various parameters, a sales session, or “negotiation” for an item will be held after the system accepts a sales bid from one or more suppliers. During the “negotiation” potential consumers are encouraged to submit contingent buyer commitments (CBC) to purchase a quantity of the item if the price does not exceed a maximum value included in the CBC. If no CBC is satisfied by the accepted supplier bid, no transactions occur. In various embodiments, a supplier's bid may require a minimum quantity of an item be purchase in a given transaction before any item is required to be sold. In various embodiments, a “negotiation” exists for a predetermined duration and transactions are not processed until the conclusion of the “negotiation”. “Item”, as used in this document, refers to the subject of the negotiation. In various embodiments, an item is a product, a service, a combination of products, a combination of services or a combination of one or more products and services.

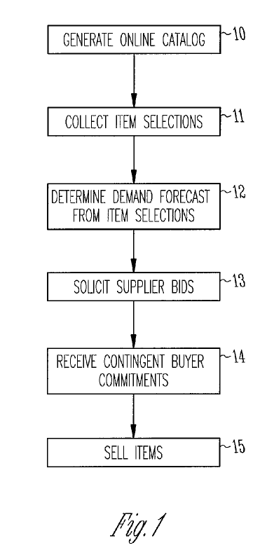

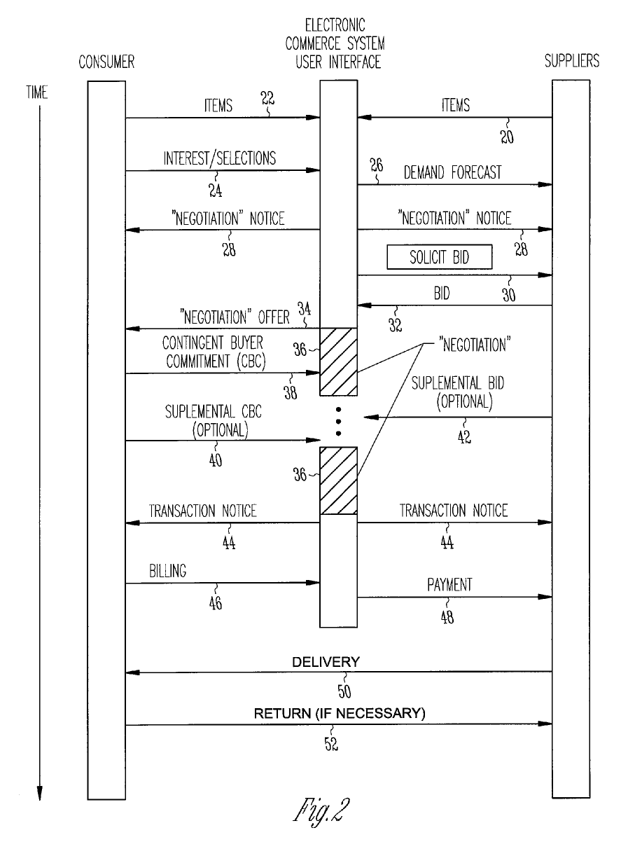

FIG. 1 shows a flow diagram for a method of developing electronic commerce according to one embodiment of the present subject matter. The method includes generating an online catalog of items available for commerce 10, collecting item selections for interested consumers 11, determining a demand forecast for each item based on the selections 12, soliciting supplier bids to supply the demand forecast 13, receiving contingent buyer commitments to purchase an item during a “negotiation” session 14, and selling items that satisfy both a consumer's contingent buyer commitment and a supplier's bid 15. FIG. 1 is provided to demonstrate some of the process used in one embodiment; however it is understood that the exact process may vary without departing from the scope of the present subject matter.

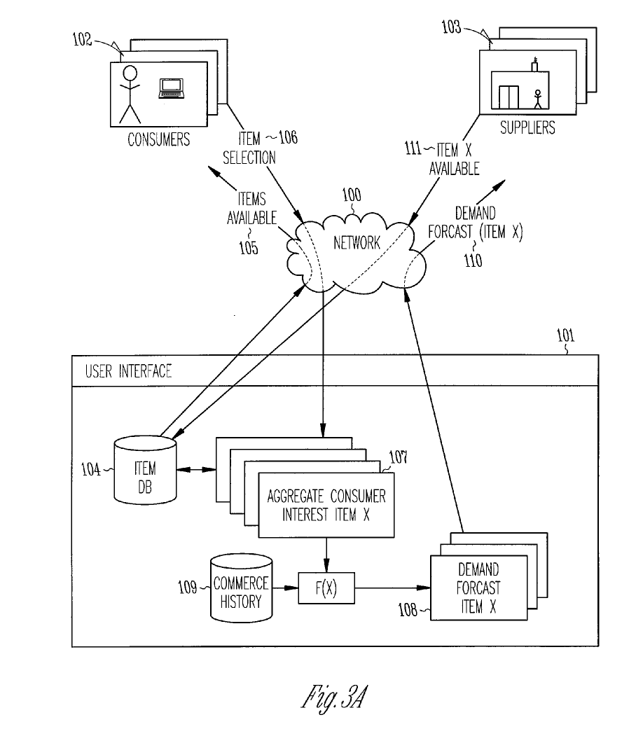

FIG. 2 shows an information flow diagram for developing electronic commerce according to one embodiment of the present subject matter. FIG. 2 illustrates conceptually the temporal information flow with time proceeding vertically from the top of the figure to the bottom. FIG. 2 begins with adding one or more items to a website catalog of an electronic commerce system. The operator of the electronic commerce system can input various items into the electronic catalog. In various embodiments, items may be added by suppliers 20, also known as vendors or sellers. Suppliers download item information to the website. Item information may, for example, include, but is not limited to, item description, item picture, Universal Product Code (UPC), model number, manufacturer, service provider or combinations thereof. In some embodiments, the website allows consumers to add items to the catalog 22. For example, if a consumer notices a particular item at a store and would be interested in purchasing the item if offered at a better price, the consumer could add the item to the catalog. One goal of the consumer would be to see if enough other people would select the item such that a supplier of the item would offer to sell the item at a price more attractive then what the item is currently offered for in other commerce channels. In various embodiments, items may be added to the online catalog at any time.

The information flow of FIG. 2 continues with consumers browsing the catalog and selecting items 24 that interest them and which the consumers may consider buying for the right price. In some embodiments, a consumer is provided an opportunity to enter a desired quantity the consumer may consider purchasing. As such, the consumer is not committed to a purchase, but merely free to express interest in a product.

In various embodiments, the online catalog does not display a sale price for the item. In some embodiments, a retail price may be associated with some items for reference. In various embodiments, the online catalog displays additional system information with each item. For example, the online catalog may display the aggregated quantity of an item consumers have so far indicated they may be interested in purchasing, a demand forecast generated by the website system 26, or both the aggregated quantity and the demand forecast. The intention of the demand forecast is to predict the actual number of sales of the item of the item were to be offered for sale. In various embodiments, the demand forecast is determined from the aggregated quantity and historical commerce data related to the item.

In various embodiments, when a demand forecast attains a predetermined threshold, the website system schedules a “negotiation” for the item and begins to prepare for the “negotiation” 28. Preparation for the “negotiation” include soliciting suppliers to submit a bid to satisfy the demand forecast for the item 30, receiving the bids 32 and selecting one or more bids upon which to offer the item for purchase 34. In various embodiments, soliciting suppliers to submit bids includes notifying the suppliers of the opportunity to bid using electronic messaging. Consumers are notified of a “negotiation” via the website. In various embodiments, consumers who are registered on the website are notified electronically using the consumers preferred method of communication and protocol, including, but not limited to, e-mail, page, text message or combination thereof. A supplier's offer includes a price or price schedule at which the supplier will sell the item. In various embodiments, the offer will include a minimum aggregate sales quantity that must be reached before the supplier is committed to selling any quantity of an item.

The “negotiation” 36 begins when the offer 34 for the item is displayed on the website. The offer will include a price or price schedule. In response to the offer, consumers submit contingent purchase commitments (CBC) 38. A consumer's CBC binds the consumer to purchasing the indicated quantity for the indicated price if a supplier bid satisfies the contingencies of the commitment, for example the price and quantity of the commitment. In a negotiation that includes a minimum aggregate sales quantity, the quantity of each CBC satisfying the offer is updated and compared to the minimum quantity. In various embodiments, the aggregate CBC count is displayed and updated on the website during the negotiation. Displaying the aggregate CBC count information may induce action by either the consumers or the suppliers to reach an agreement. For example, if the count does not satisfy the minimum aggregate sales quantity, interested consumers may be encouraged to commit to purchasing a larger quantity of the item through additional or supplemental CBCs 40. As another example, the suppliers may be willing to reduce their price, their minimum aggregate sales quantity or both through the submission of a supplemental supplier bid 42.

At the conclusion of a “negotiation”, the website system completes the transactions where a CBC satisfies an offer. Completing the transaction, or sale, includes notifying the consumer and supplier of successful transaction conditions 44. Completing the transaction, or sale, further includes charging the consumer for the purchase 46 and forwarding payment to the supplier 48 along with the consumers' shipping information or other information needed for the supplier to provide delivery 50 of the item to the consumer. The consumer then receives the item from the supplier. If the consumer has a problem with the item, the consumer and supplier negotiate a return 52 or some other solution directly between each other. In various embodiments, the billing may occur between the suppliers and consumers. In various embodiments, the returns may take place using the operators of the electronic commerce system. In various embodiments, a “negotiation” lasts for a predetermined period of time, for example 76 hours. In various embodiments, a “negotiation” ends when the supplier's inventory of an item is exhausted. Differences in process order and operations may occur without departing from the scope of the present subject matter.

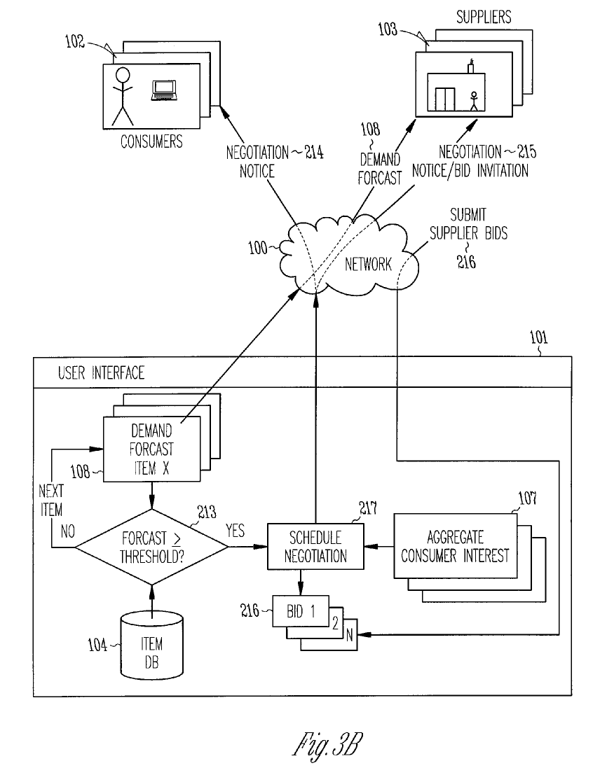

FIGS. 3A-D are process flow diagrams for a web commerce system according to one embodiment of the present subject matter. FIG. 3A shows a network commerce system with a user interface 101 to a network 100. Users, consumers 102 and suppliers 103, use the interface to purchase or sell items available using the system. Users connect to the system using a device with a network interface such as a computer or a cell phone. The system includes at least one electronic storage area such as a database. In the illustrated embodiment, an item database 104 includes information about items available for commerce. In various embodiments, users can browse information about items available on the system 105 using a web browser connected to a dedicated web site. Examples of web browsers include, but are not limited to, Microsoft Internet Explorer, Firefox, and Netscape In various embodiments, users can browse a dedicated web site for available items using internet capable mobile devices, such as cell phones and Personal Data Assistants (PDAs) for example. A consumer who finds an item of interest while browsing the system can select the item 106 for potential future purchase. In general, selecting an item indicates a consumer's interest in the item. Thus, selecting an item associates the information about the consumer with the item in a database. In various embodiments, selecting an item includes associating the item with other items selected by the consumer. In some embodiments, upon selecting an item, the consumer is allowed to associate the item with other selected items in one or more lists of items stored on the system. For example, a consumer my have items selected the area associated with various rooms in the consumer's home. The consumer, upon finding an interesting item, may select the item and then add it to a list of other similar items selected by the consumer.

In various embodiments, users are required to register with the system as a consumer before selecting items for future purchase. Registering allows the system to track item selections. Registering allows the system to provide notice to users associated with a selected item of events related to the item, for example, a sale of the item. In various embodiments, consumer selections require the consumer to select a quantity of a selected item the consumer is interested in purchasing. In various embodiments the system allows the quantity to default to one unless another quantity is selected.

Consumer selections of items and corresponding quantities are received by the system. The received quantity values from each consumer for an item are indicative of the consumers' interest in the item. Aggregate consumer interest 107 for an item is the sum of all quantities of the item received from consumers. In various embodiments, aggregate consumer interest is stored in the item database 104. In various embodiments, aggregate consumer interest 107 is made available to all users connected to the system. In the illustrated embodiment, a demand forecast 108 for the item is determined from the aggregate consumer interest of the item 107 and historical commerce data 109. The demand forecast is a predictive indicator of expected sales of the item. In various embodiments, the demand forecast is made available to users 110 connected to the web commerce system. In various embodiments, historical commerce data 109 includes data recorded from the activities of the system. In various embodiments, historical commerce data includes characteristics of the consumers, such as age, residence, credit rating, prior commerce activity on the system or combination thereof. In various embodiments, historical commerce data 109 includes characteristics of the item, such as, prior sales on the system, prior demand forecast data, prior aggregate demand data, commerce information or related items or combination thereof.

In certain applications, a supplier may monitor the demand forecast 110 for items the supplier may wish to sell using the system. In various embodiments, suppliers 103 connected to the system enter information about items they may wish to sell into the item storage area 111 of the network commerce system. In various embodiments, a supplier indicates an available inventory of an item and the supplier is identified with the item in the system storage area.

FIG. 3B illustrates a process flow diagram for a network commerce system according to one embodiment of the present subject matter. The system includes one or more consumers 102 and one or more suppliers 103 connected to the system through a network 100, such as the Internet and a user interface 101. In various embodiments, the illustrated web commerce system includes the features of the web commerce system of FIG. 1. In various embodiments, a storage area 104 of the system will include a system-established demand forecast threshold for an item. The demand forecast threshold is used to determine if and when a “negotiation” is scheduled. In the illustrated embodiments, the demand forecast 108 is made available to the one or more suppliers 103. In the illustrated embodiment, the network commerce system evaluates the demand forecast of available items against a demand forecast threshold 213. If the demand forecast for an item meets or exceeds the demand forecast threshold, a “negotiation” is scheduled. In various embodiments, a “negotiation” is a period of time, for example 76 hours, within which interested consumers can submit binding offers to purchase an item in response to a supplier bid to sell the item. In various embodiments, a “negotiation” will last indefinitely. In various embodiments, a “negotiation” will conclude when a supplier's inventory of the item are exhausted.

In various embodiments, upon scheduling a “negotiation”, the system notifies interested consumers 214. An interested consumer includes those consumers associated with an item. In various embodiments, a consumer is associated with an item in a system database when the consumer selects the item for potential future purchase. In various embodiments, consumers are identified using the aggregate consumer interest data 107. In various embodiments, consumers maintain one or more lists of item selections on the system and the system searches the lists to identify consumers interested in a particular “negotiation” item. Items are classified and consumers are identified using recorded selections of related items of the same classification as a scheduled “negotiation” item. Consumers are generally notified using a web page to display the upcoming “negotiation”. Consumer notification of a “negotiation” includes contacting the consumer electronically, such as, sending an e-mail, paging, text messaging, voice mailing or combination thereof. A consumer notification may include information about the item including a recent aggregate consumer interest of the item, a recent demand forecast for the item, price, or various pricing levels, or tiers or combination thereof.

In the illustrated embodiment, one or more suppliers 103, also known as sellers or vendors, are notified of a scheduled “negotiation” 215. In various embodiments, suppliers are notified using a web page to display the upcoming “negotiation” schedule. In various embodiments, supplier notification of a “negotiation” includes contacting the supplier electronically, such as sending an e-mail, paging, text messaging, voice mailing or combination thereof. In various embodiments, supplier notification 215 will include information about the item including a recent aggregate consumer interest 107 of the item, a recent demand forecast 108 for the item, price, or various pricing levels, or tiers or combinations thereof. A supplier notification of an upcoming “negotiation” may include an invitation to submit a supplier's bid. A supplier bid 216 is an offer to provide items for purchase. As explained herein, the system will receive contingent buyer commitments (CBCs) in response to an accepted supplier bid. Where the supplier bid and the consumer commitment agree on terms, a binding transaction will be formed unless an unmet contingency remains.

In various embodiments, a supplier bid 216 includes a price, a price schedule, a minimum aggregate commitment quantity, an inventory quantity or combination thereof. The price included in a supplier bid is the minimum price the supplier will sell the item. In supplier bids including a price schedule, the schedule may be tiered indicating the supplier will sell the item for a range of prices depending on the aggregate quantity of units sold. In supplier bids including a minimum aggregate commitment quantity, no items will be sold until the minimum aggregate commitment quantity is met. This is an example of a situation where even though a consumer's commitment is met by the supplier's bid, a contingency remains.

In various embodiments, supplier bids 216 are received before a “negotiation” is scheduled 217. In various embodiments, supplier bids are received up to the beginning of the scheduled “negotiation”.

FIG. 3C illustrates a process flow diagram for a network commerce system according to one embodiment of the present subject matter. In various embodiments, the illustrated system includes the features of FIG. 1, FIG. 2 or a combination thereof. The system includes one or more consumers 102 and one or more suppliers 103 connected to the system through a network 100, such as the Internet and a user interface 101. In the illustrated embodiment, supplier bids 216 are evaluated during a bid selection process 318 using historical commerce data 109. Examples of evaluation criteria for accepting a supplier bid include, but are not limited to, the supplier's past ability to fulfill demand estimates and the number and severity of complaints against the supplier. In various embodiments, the supply of an item is verified 319 as part of the bid selection process. In various embodiments, a supplier's historical activities are considered during the bid selection process. In various embodiments, bid selection is automated using electronic inventory verification and scores associated with prior supplier activities. Upon accepting a bid, the web commerce system notifies the supplier identified with the accepted bid 320 of the bid selection process result. In various embodiments, the system notifies suppliers identified with rejected bids 321 of the bid selection process result. In various embodiments, the accepted bid is made available to users of the system 322 upon commencement of the scheduled “negotiation” 323. In various embodiments, the accepted bid is made available to system users prior to the scheduled “negotiation”.

Upon commencement of a “negotiation”, the system can receive contingent buyer commitments (CBCs) 324 for the “negotiation” item from one or more consumers. CBCs 324 are binding offers to purchase an item provided any contingency is met. In various embodiments, CBCs include a price the consumer is offering to pay for the item and a quantity of the item the consumer is willing to purchase for that price. In various embodiments, the price included in the CBC represents the per unit price. In various embodiments, a CBC includes a price schedule, for example, a schedule of sequentially lower per unit prices for sequentially larger quantities. The system continues to allow reception of CBCs during the duration of the “negotiation”. During the “negotiation” the network commerce system negotiation process manager 326 provides “negotiation” status information 325 electronically. In various embodiments, “negotiation” status information 325 includes aggregate consumer interest for the item, demand forecast for the item, minimum aggregate commitment quantity, actual commitment quantity, supplier bid information, inventory of the item, time remaining for the current “negotiation” or combination thereof.

FIG. 3D illustrates a process flow diagram for network commerce system according to one embodiment of the present subject matter. In various embodiments, the illustrated system includes features of the embodiments of FIGS. 1-3 or combinations thereof. The system includes one or more consumers 102 and one or more suppliers 103 connected to the system through a network 100, such as the internet and a user interface 101. The network commerce system includes a negotiation process manager 326, a transaction processor 327, a payment processor 428 and one or more storage devices for storing data including consumer information 329, supplier information 429 and commerce history 109 of the system. The illustrated embodiment also includes a connection using the web to one or more financial accounts 330. In various embodiments, the financial accounts 330 include accounts identified with one or more of the consumers 102, one or more of the suppliers 103, the operators of the network commerce system or combination thereof.

The illustrated embodiment of the network commerce system illustrates process flow as a “negotiation” concludes. The negotiation process manager 327 monitors conditions triggering the conclusion of a “negotiation” 331. In the illustrated embodiment, a condition includes the scheduled conclusion of the “negotiation”. In various embodiments, exhausting the supply of the “negotiation” item triggers the conclusion of a “negotiation”. In the illustrated embodiment, the negotiation process manager 326 continues to provide “negotiation” status 325 during the “negotiation”. In the illustrated embodiment, the network commerce system continues to receive contingent buyer commitments 324 during the “negotiation”. In various embodiments, consumers are not limited in the number of contingent buyer commitments 324 they submit. In some embodiments, consumers are limited to a predefined number of submitted contingent buyer commitments.

In various embodiments, the network commerce system will receive supplemental supplier bids 332 during a “negotiation”. An accepted supplemental supplier bid 332 replaces, modifies, adds to, or combination thereof, conditions of a current accepted supplier bid. In various embodiments, a supplemental supplier bid 332 is accepted if the supplemental conditions would continue to satisfy contingent buyer commitments 324 currently satisfied by the current supplier bid. Suppliers would typically use supplemental supplier bids 332 to increase sales of the “negotiation” item under the contingencies of the received contingent buyer commitments 324.

In the illustrated embodiment, upon conclusion of the “negotiation”, a transaction processor 327 evaluates the received contingent buyer commitments 424 against the accepted supplier bid. The transaction processor 427 uses previously stored consumer and supplier information 329 to notify users of each transaction 333 binding the party to either purchase or sell the “negotiation” item. In various embodiments, the notification 333 is transmitted electronically using, for example, e-mail, paging, text messaging, short message service (SMS) text messaging, voice mail or combination thereof. In various embodiments, a payment processor 328 receives transaction information from the transaction processor 327 and electronically transfers payments 334 from the consumer/buyers to the supplier(s). In various embodiments, before a user is allowed to use the network commerce system for purchasing or selling an item, the user must supply the system with financial information such that the system can complete any transactions involving the user. Credit card numbers, Paypal account information, billing address and mailing address are examples of financial information stored and associated with users registering on the system in various embodiments.

In various embodiments, the payment processor 328 deducts a commission 335 from each payment transaction. For example, if a consumer's contingent bid of $100 for an item is satisfied, the payment processor receives the consumer's payment information and processes the transaction such that the supplier account is credited $100. In various embodiments, the payment processor also charges the consumer's account for applicable taxes and credits the suppliers account for the same tax charge requiring the supplier to transfer the collected taxes to the appropriate taxing authority. In various embodiments, the payment processor 328 charges the consumer's account a commission and credits an account identified with the web commerce system the commission amount. In various embodiments, the commission is a percentage of the purchase price before taxes. In various embodiments, a flat fee is transferred from the supplier's account to an account identified with the network commerce system. In various embodiments, a commission is determined using the difference between a consumer's higher contingent commitment price and a supplier's lower bid price according to predefined rules. For example, if a consumer initially indicated a purchase price of $100 but the supplier subsequently submitted his bid at $95, the commission, or fee, would be based on the final agreed-to price of $95.

In various embodiments, upon notifying the supplier of the transactions 333, the supplier then delivers 336 the item to the consumers. In various embodiments, the supplier handles any return issues 337 arising as a result of the “negotiation” transaction. Post-sale returns or other customer service issues are negotiated directly between the purchaser and the consumer utilizing the supplier's policy for handling such issues, which is clearly stated at the time of purchase.

In various embodiments, the network commerce system includes a social networking module for allowing users to electronically discuss various topics. In various embodiments, the social networking module includes a social network in which access is restricted to only consumers using the network commerce system. In various embodiments, the social networking module includes a social network in which access is restricted to only suppliers using the network commerce system.

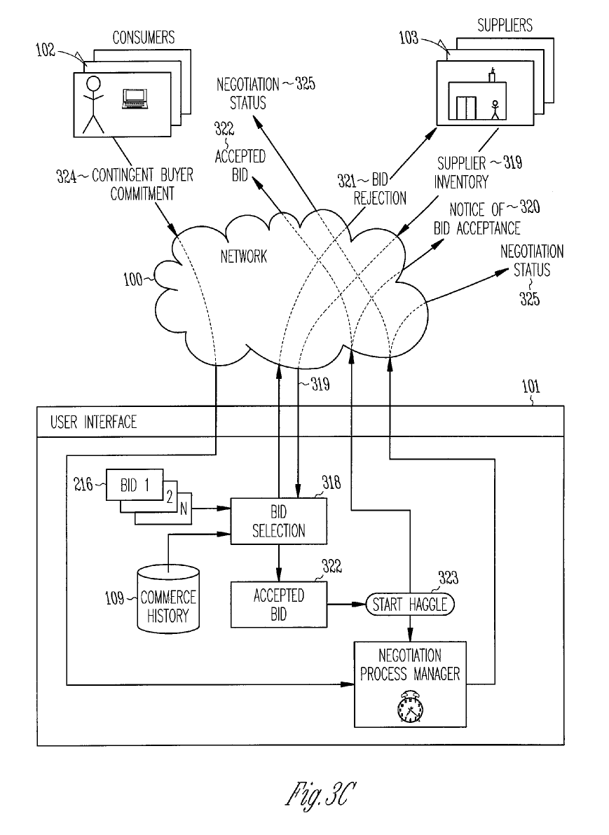

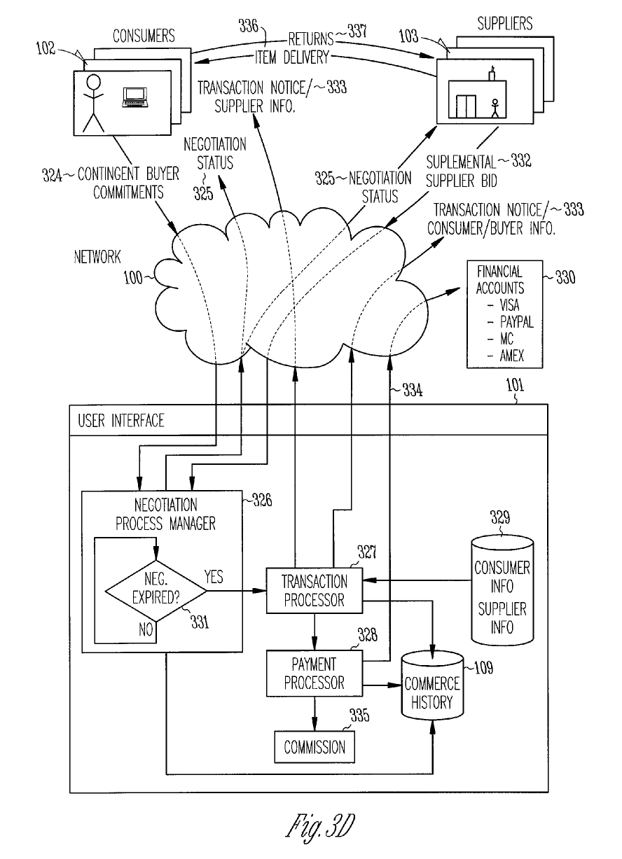

FIG. 4 illustrates a process flow diagram of a network commerce system according to one embodiment of the present subject matter. The illustrated system shows a plurality of consumers 402 and suppliers 403 connected through a network 400 to a user interface 401. The illustrated system includes an inventory management system (IMS) interface 440, an item storage area or database 404 and an item search engine 460. In the illustrated system, the IMS interface 440 connects to one or more suppliers' inventory management systems 443 and monitors inventory of items in the suppliers' inventory and available on the network commerce system. In the illustrated system, items are identified with a Universal Product Code (UPC). In various embodiments, the network commerce system uses the UPC to index products, aggregate products with similar qualities, provide users of the system with additional information about an item identified with a UPC or combination thereof.

In various embodiments, the network commerce system allows a user to add items to the item storage area or item database 461. To add an item the user enters the item name, description, picture, UPC code or combination thereof. In various embodiments, a user can select the newly added item to show consumer interest in the item.

In various embodiments, users search for items 462 using an item search engine. In various embodiments, an item search requires at least one search criteria be entered by the user, such as an item keyword, UPC or combination thereof. Upon entering the search criteria, the item search engine will search the item database 404 and return a result summary 463 of the search. If items are found that match the search criteria, the user is given an option of selecting one of the search result items to show consumer interest in the item.

In various embodiments, the search engine will respond to a supplier search 464 with item information important to a supplier 464, such as, demand forecast, aggregate consumer demand information, system-established thresholds or combination thereof. Such information can help prepare the supplier for an upcoming “negotiation”.

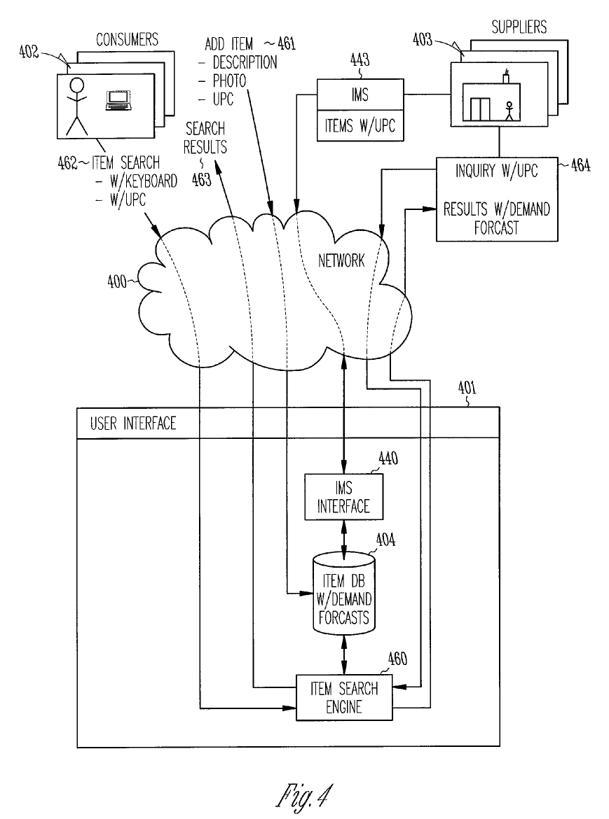

FIG. 5 illustrates a process flow diagram for a network commerce system according to one embodiment of the present subject matter. The illustrated embodiment shows a plurality of businesses, buyers 541 and sellers 542, connected to a network commerce system through a network and an interface 501. The network commerce system includes an inventory management system interface (IMS Interface) 540 connected to one or more of the connected businesses' inventory management systems (IMS) 543. In various embodiments, the IMS interface 540 allows a business to automatically download and update 544 items the business has available in the system. Adding items, deleting items and changing an item's description or picture are examples of some the automatic IMS interface functions. In various embodiments, the IMS Interface 540 automatically updates the item storage area 504 of the network commerce system with inventory information of available items. In various embodiments, the IMS interface stores return inventory 545 information from a connected user's IMS 543. Return information can include, for example, the quantity of an item the user has on hand to be returned to a suppler, the cost of returning the item, the initial user cost of the item or combination thereof.

The illustrated system also includes a returns processor 546. The returns processor 546 monitors the returns information 545 of items available on the network commerce system. In various embodiments, the returns processor 546 receives Open-to-Buy (OTB) purchase order notices 547. An Open-to-Buy order allows the system to match returned inventory, surplus inventory, ordinary inventory or combination thereof of one or more businesses with an OTB order from one or more other businesses.

Upon locating a matching OTB purchase order, the returns processor 546 sends an order fulfillment notice 548 to the OTB purchase order entity, purchases the return items from the selling entity, or entities, with a purchase order and a notice to ship to the OTB entity 549. The returns processor 546 configures the transaction under rules previously established or contained in the returns information. In various embodiments, the returns processor 546 only triggers the transaction if certain thresholds are met, such as, a minimum profit for the selling entity and a minimum profit for the operators of the network commerce system. In various embodiments, the returns processor will submit a bid to fulfill the OTB requirement under terms to trigger the transaction, but terms different than the OTB purchase order. Upon receiving order confirmation 550, a payment processor 551 transfers payment 552 from the buying entity 541 to the operator of the network commerce system and forwards a payment 553 to the selling entity 542.

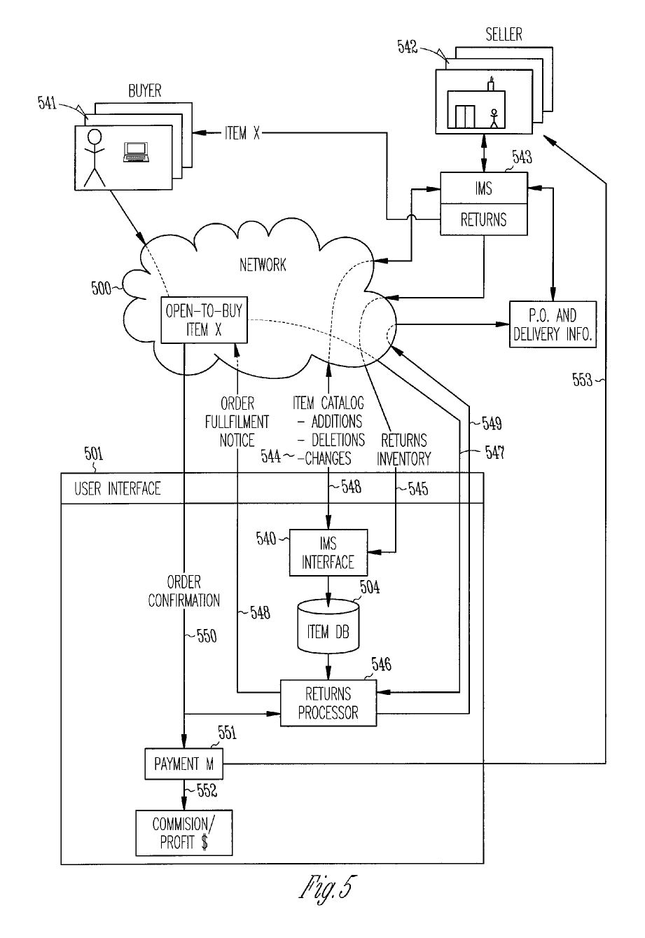

FIG. 6 illustrates a flow diagram of a method for conducting commerce using a network according to one embodiment of the present subject matter. The illustrated flow includes receiving consumer interest in an item 671, determining a demand forecast for the item as function of consumer interest for the item and historical commerce data of the item 672, conducting a “negotiation” for the item 673 and processing transactions created during the “negotiation” 674.

In various embodiments, receiving consumer interest in an item includes receiving a selected quantity of an item. In various embodiments, receiving consumer interest in an item includes selecting an item for potential purchase. In various embodiments, receiving consumer interest includes adding an item to the system and selecting the item for potential purchase. In various embodiments, receiving consumer interest for an item includes searching for an item with a keyword, UPC or combination thereof and selecting an item from the search results.

In various embodiments, providing an indication of consumer interest does not bind the consumer to purchase the item or any quantity indicated. In various embodiments, providing an indication of consumer interest does not require the consumer to provide a price at which the consumer would be purchase the item indicated or the quantity thereof. In various embodiments, the consumer is required to register with the system to provide payment information before providing an indication of the consumer's interest in one or more items.

The system uses the aggregate consumer interest in an item in determining a demand forecast for the item. Determining a demand forecast includes using the received consumer interest, historical consumer data and historical item data. In various embodiments, the historical consumer data includes, individual consumer experience using the system, age of the consumer, sex of the consumer, residence of the consumer or combination thereof. Historical item data may include, for example, performance data from prior “negotiations”, prior aggregate consumer interest data, prior demand forecast data, whether the item is a seasonally popular item and the current proximity to the season, average retail price of the item, the popularity of the item or combination thereof.

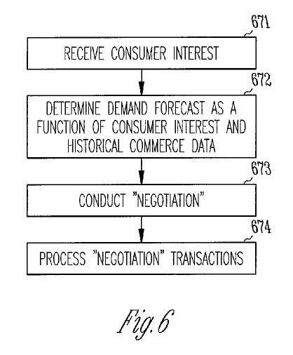

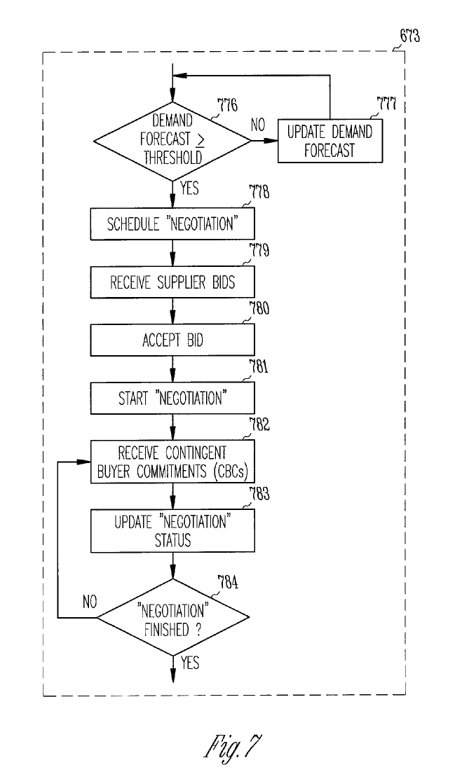

FIG. 7 illustrates a flow diagram for conducting a “negotiation” for an item 673 according to one embodiment of the present subject matter. In the illustrated embodiment, the process branches depending upon whether the demand forecast for the item meets a system established threshold 776. In various embodiments, each item is associated with a system-established threshold. In various embodiments, a system-established threshold must be met to schedule a “negotiation”. If the demand forecast does not meet the system-established threshold, the process continues to monitor the demand forecast 777 for the item and update the forecast as new consumer interest is received.

If the demand forecast does meet the system-established threshold, the process includes scheduling a “negotiation” 778 and receiving supplier bids 779 for the item. In various embodiments, consumers interested in the item and suppliers capable of supplying the item are notified of the scheduled “negotiation.” In various embodiments, scheduling a negotiation includes notifying interested users, both consumers and suppliers, of the upcoming “negotiation.” In such embodiments, notifying a supplier of a scheduled “negotiation” includes inviting the supplier to submit a supplier bid. In various embodiments, notifying an interested consumer of a scheduled “negotiation” includes identifying an interested consumer using the received consumer interest. In various embodiments, consumers maintain one or more lists of items the consumer is interested in purchasing and notifying an interested consumer of a scheduled “negotiation” includes searching consumer lists for indications of interest in the “negotiation” item an identifying the consumer associated with a list containing the “negotiation” item.

The illustrated flow diagram includes receiving supplier bids for the item 779, accepting a supplier bid 780, starting the “negotiation” 781, receiving contingent buyer commitments 782, updating the “negotiation” status 783 and closing the “negotiation” 784.

Supplier bids include a price at which the supplier will sell the item if a contingent buyer commitment includes a purchase price at or above the bid price. In various embodiments, the supplier bid includes a minimum commitment threshold. The minimum commitment threshold is a contingency that requires a minimum aggregate number of item commitments before the supplier will sell one item, even if one or more contingent buyer commitments satisfy the bid price. As explained above, in various embodiments, a supplier will include a pricing schedule with a supplier bid.

The illustrated process includes accepting a bid for the “negotiation” 980. In various embodiments, inventories of suppliers submitting bids are verified before accepting a supplier bid for a “negotiation”. In various embodiments, historical performance of a supplier is provided for comparison with competing suppliers to assist in accepting a supplier bid. In various embodiments, a supplier rating is provided for evaluation in accepting a supplier bid. In various embodiments, accepting a supplier bid includes notifying the supplier of the acceptance.

In various embodiments, starting the “negotiation” 781 includes notifying interested consumers if the “negotiation”. During the “negotiation”, the process includes receiving contingent buyer commitments. CBCs are biding offers to purchase an item provided any contingency is met. In various embodiments, CBCs includes a price the consumer is offering to pay for the item and a quantity of the item the consumer is willing to purchase for that price. In various embodiments, the price included in the CBC represents the per unit price. In various embodiments, a CBC includes a price schedule, for example, a schedule of sequentially lower per unit prices for sequentially larger quantities. The system continues to allow reception of CBCs during the duration of the “negotiation”.

In various embodiments, the process includes updating users with the status of the “negotiation” 783. In various embodiments, “negotiation” status information includes aggregate consumer interest for the item, demand forecast for the item, minimum aggregate commitment quantity, actual commitment quantity, supplier bid information, inventory of the item, time remaining for the current “negotiation” or combinations thereof.

The illustrated process then branches depending upon whether the “negotiation” is finished 784. In the illustrated embodiment, if the “negotiation” is not finished, the process includes receiving additional CBCs 782, if any, and updating “negotiation” status 783.

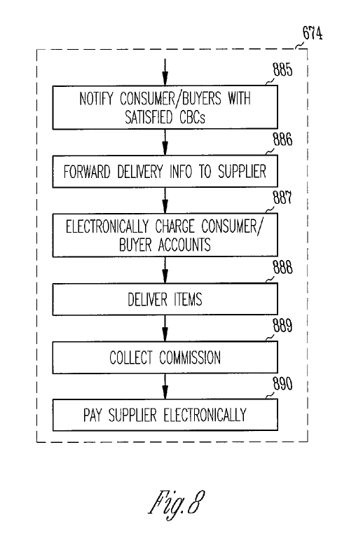

FIG. 8 illustrates a process for processing a transaction 674 arising from a “negotiation” according to one embodiment of the present subject matter. In various embodiments, processing “negotiation” transactions includes notifying consumers identified with a satisfied contingent buyer commitment 885, forwarding delivery information to a supplier 886, electronically charging accounts identified with satisfied contingent buyer commitments 887, delivering items to consumers 888 and handling item returns, collecting a commission 889 and electronically paying a supplier 890.

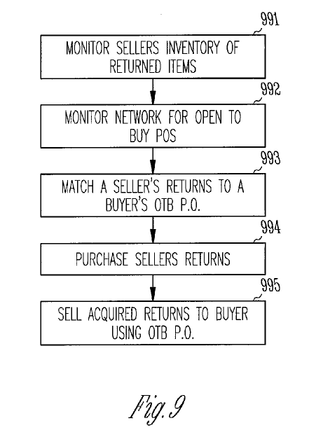

FIG. 9 shows a flow diagram of a process for electronic commerce between businesses using a supplier's returns inventory according to one embodiment of the present subject matter. The method includes monitoring a supplier's inventory of returned items 991, monitoring a network, including the internet, for example, for “Open to Buy” (OTB) orders 992, matching a supplier's return inventory with a consumer's OTB order 993, purchasing at least a portion of the supplier's returns inventory 994 and selling the acquired returns to the consumer using the OTB order 995.

This application is intended to cover adaptations or variations of the present subject matter. It is to be understood that the above description is intended to be illustrative, and not restrictive. The scope of the present subject matter should be determined with reference to the appended claims, along with the full scope of equivalents to which such claims are legally entitled.

What is claimed is:

1. A method of electronic commerce for a product, the method comprising:
collecting consumer interest data for the product in a database using a network;
determining a demand forecast for the product using the consumer interest data;
electronically receiving selected inventory information from at least one supplier;
monitoring a return inventory of the product of the at least one supplier;
presenting a price for a sale of the product from the return inventory of the at least one supplier to a plurality of potential consumers; and
electronically collecting contingent buyer commitments in response to the price.

2. The method of claim 1, wherein determining a demand forecast for the product includes using historical product data.

3. The method of claim 1, wherein electronically receiving selected inventory information from at least one supplier includes using an inventory management system of the at least one supplier.

4. The method of claim 1, further comprising determining the demand forecast satisfies a predetermined demand forecast threshold;

5. The method of claim 1, further comprising determining the return inventory satisfies the predetermined demand forecast threshold.

6. The method of claim 1, wherein monitoring a return inventory includes monitoring a return inventory of the product of the at least one supplier using the supplier's inventory management system.

7. The method of claim 1, further comprising electronically charging an account for each contingent buyer commitment satisfying the price.

8. The method of claim 1, wherein determining a demand forecast for the item includes using historical commerce data for the product.

9. The method of claim 1, wherein presenting the price for the item to a plurality of potential consumers, includes presenting the price to one or more retailers with Open-to-Buy orders for the item.

10. The method of claim 9, further comprising fulfilling the Open-to-Buy orders electronically.

11. The method of claim 1, wherein presenting a price includes identifying the plurality of potential customers from the collected consumer interest data.

12. The method of claim 1, wherein presenting a price includes presenting a price electronically to a plurality of potential customers.

13. The method of claim 12, wherein presenting a price electronically includes transmitting a text message.

14. The method of claim 12, wherein presenting a price electronically includes sending an e-mail.

15. The method of claim 12, wherein presenting a price electronically includes sending a voice-mail message.

16. The method of claim 1, wherein presenting a price includes presenting a price using a dedicated web site.

17. The method of claim 1, wherein collecting consumer interest include collecting consumer interest using a dedicated web site.

18. The method of claim 1, wherein monitoring a return inventory of a product includes using a UPC identifying the product.

19. The method of claim 1, wherein monitoring a return inventory of a product includes using a brand and model number identifying the product.

20. The method of claim 1, wherein monitoring a return inventory of a product includes using a stock keeping unit (SKU) number.
